(19) United States
(12) Patent Application Publication
(10) Pub. No.: US 2003/0182663 A1
(43) Pub. Date: Sep. 25, 2003

(54) System and method for sharing user comments on TV screens

(75) Inventors: Greg David Gudorf, San Diego, CA (US); Aaron John Dew, San Diego, CA (US); Anthony Lionel Creed, San Diego, CA (US); Matthew Chang, San Diego, CA (US); Rolf Toft, San Francisco, CA (US)

Correspondence Address: John L. Rogitz, Rogitz & Associates, Suite 3120, 750 B Street, San Diego, CA, 92101, US

(73) Assignees: SONY CORPORATION, Tokyo (JP); SONY ELECTRONICS INC., Park Ridge, NJ

(21) Appl. No.: 10/106,674

(22) Filed: Mar. 25, 2002

(51) Int. Cl. H04N 7/173; H04N 7/18; H04N 7/16

(52) U.S. Cl. 725/110; 725/78; 725/109; 725/135

(57) ABSTRACT

A method to enable multiple TV viewers in discrete physical and/or temporal locations, to share the TV viewing experience by using audio and/or visual comments triggered by a remote control in conjunction with a TV which may be connected to one or more other TVs. The connection may be wireless (such as IEEE 802.11, Bluetooth, etc.) or wired means (such as POTS line, Ethernet cabling, coax cabling, etc.). The TVs may furthermore communicate directly with each other on a peer-to-peer basis or via an intermediary server(s). Alternate embodiments permit time-shifting comments.

### FIELD OF THE INVENTION

The present invention relates generally to television systems.

### DESCRIPTION OF THE RELATED ART

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the abovementioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, in which preselected Internet pages are loaded once into a television during manufacture and never subsequently updated, with the preselected pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a TV remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. The object of the present invention is to provide a TV system that accommodates lean back experiences better than existing systems.

### SUMMARY OF THE INVENTION

A system includes first and second user TVs and an input device associated with each. The input device can be manipulated by a user to input comments that are displayed on the other user TV. In one preferred embodiment, the input device is a remote control device. If desired, the system can be a peer-to-peer system, wherein the TVs communicate directly with each other by wireless (such as rf links including 802.11, bluetooth, etc.) or wired means (such as POTS telephone, cable coax, CAT-5 Ethernet, etc.), or it can be a server-based system, wherein a comment server acts as an intermediary between the two TVs and transfers comments input at one TV to another TV. In any case, the comment can be presented along with a symbol or other ID that is associated with the user.

In another aspect, a method is disclosed for sharing TV program-related comments between first and second users of respective first and second TVs. The method includes receiving a comment from the first user via an input device in wireless communication with the first TV, and sending the comment to the second TV for display of the comment thereon.

In still another aspect, a TV includes a TV monitor displaying televised content. The monitor also displays at least one comment received from a companion TV.

In another embodiment, the system may contain one or more display devices (TV, monitor, etc.) along with an audio-visual time-shifting device (such as a PVR personal video recorder like TiVo, a home server, or a VCR video cassette recorder).

The first viewer uses the input device (remote control, keyboard, etc.) to add audio-visual commentary to a program being viewed. The commentary and synchronization data is stored on the audio-video time-shifting device. It may be transmitted to another time-shifting device at another location for viewing by a second viewer at a physically discrete location from the first viewer.

Alternatively, in another application, the second viewer may watch the audio-video content later than the first utilizing the same equipment, just time-shifted. Thus, families can share their comments on programming even if they are unable to watch together. The second viewer now can watch the audio-video content with the first viewer's audio-visual commentary superimposed and synchronized with the content viewed.

In still another aspect, this functionality may be applied to read-only audio-video media (such as DVD, CD, game consoles). These implementations may transmit the comment and synchronization data peer-to-peer or via an intermediary server. An alternative aspect uses removable media to store the comment and synchronization information.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention;

FIG. 2 is a block diagram of an alternate peer-to-peer system of the present invention;

FIG. 3 is a schematic view of a comment input device;

FIG. 4 is a flow chart of the logic of the invention;

FIG. 5 is a block diagram of an implementation where the users are only temporally separated, rather than physically;

FIG. 6 is a block diagram of a peer-to-peer implementation where both place and time shifted viewing of comments is possible;

FIG. 7 is a block diagram of a variation of FIG. 6, where an intermediary server is used;

FIG. 8 is a block diagram of an implementation where the functionality is modified for use with read-only system for time-shift comment viewing;

FIG. 9 is a block diagram showing two read-only devices which share comments by utilizing removable media to store comment and synchronization data;

FIG. 10 is a block diagram of a variation of FIG. 9 which uses a peer-to-peer connection rather than removable media;

FIG. 11 is a block diagram of a system which allows sharing of audio and/or visual commentary for game console devices (such as PlayStation, XBox, Nintendo, etc.) with a second viewer using a time-shifting audio-video device; and

FIGS. 12 and 13 are variations of FIGS. 10 and 11 respectively, where an intermediary server is used instead of a peer-to-peer connection.

### DETAILED DESCRIPTION OF THE PREFERRED EMBODIMENTS

Referring initially to FIG. 1, a system is shown, generally designated 10. As shown, the system 10 includes plural TV systems, including a user TV 12 and companion TVs 14. The TVs 12, 14 are substantially identical to each other and are physically separate from each other, perhaps located in different rooms of the same household or in different households altogether. Thus, while the disclosure below is in relation to the user TV 12, it is to be understood that it is equally applicable to the companion TVs 14. Each TV 12, 14 conventionally receives televised content at a respective content receiver 16 (e.g., an antenna, satellite dish, set-top box, etc.) for display of the content on a respective monitor 18.

While the embodiment below discusses a user TV 12 with a single housing that supports not only the monitor but also the microprocessor, memory, and in general all of the electrical components associated with the TV, it is to be understood that the term “television” encompasses any apparatus that has a television tuner and the below-described comment capability. For instance, the term “TV” encompasses the single-housing television shown in FIG. 1, as well as a conventional television in combination with a set-top box that functions in accordance with the present invention. In the latter example, the set-top box might include, e.g., the microprocessor and memory discussed below.

As shown, the user TV 12 includes a housing 20 that holds a conventional television tuner which receives the TV signals. The TV can be tuned, volume and settings established, and the below-described comments input by means of one or more user interfaces 22. In the embodiment shown, a single, potentially infrared-transmitting remote control device is shown as the user interface 22. It will be appreciated that the remote control device need not be a keyboard or keypad that is associated with a computer. Rather, it can be a conventional remote TV control that can have numeric buttons, up/down and left/right buttons, and a power button, as well as other buttons that might be conventionally provided on a TV remote control, in addition to certain novel controls described further below in relation to FIG. 3. The functions of the remote control can also be undertaken by conventional TV buttons on the user TV 12 itself. However, less preferably keyboards, keypads, motion-sensing (gesture) devices, and voice recognition input devices can also be used.

The housing 20 can also hold a comment memory or other data storage 24.

The memory or other data storage 24 can be computer memory, or a hard disk drive, optical drive, solid state storage, tape drive, removable flash memory, or any other suitable data storage medium. It can pre-store comments generated by the user of the TV 12 for subsequent transmission to the companion TVs 14, and it can store comments received from the companion TVs 14 for display on the user TV 12.

A microprocessor 26 is also supported in the housing 20, as is a communication interface 28. The microprocessor 26 executes the logic steps set forth below, and it accesses the memory 24 and communication interface 28 in accordance with the logic below.

It may now be appreciated that the microprocessor 26 controls the functions of the user TV 12 in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

In the system 10 shown in FIG. 1, the communication interface 28 communicates with a server 30, which can be, e.g., a Sony Corporation Web portal. The server 30 can be a Web server computer that accesses a customer database. Or, the server 30 of the present invention can be implemented by any appropriate computer, such as personal computers, laptop computers, mainframe computers, and the like.

In any case, the server can access a software-implemented synchronization manager to execute portions of the present invention. According to the embodiment shown in FIG. 1, the customer database can store customer or consumer identities and associated companion TV 14 data for transmitting comments between the companion TVs 14 and the user TV 12. In one embodiment, communication between the server 30 and TVs 12, 14 is undertaken via the Internet. In another embodiment, communication between the server 30 and TVs 12, 14 is undertaken via an rf links such as Bluetooth, IEEE 802.11 or via wired links such as POTS telephone modem, CAT-5 Ethernet cabling, etc. Accordingly, the communication interface 28 can be an Internet interface, telephone modem, rf transceiver, or other interface.

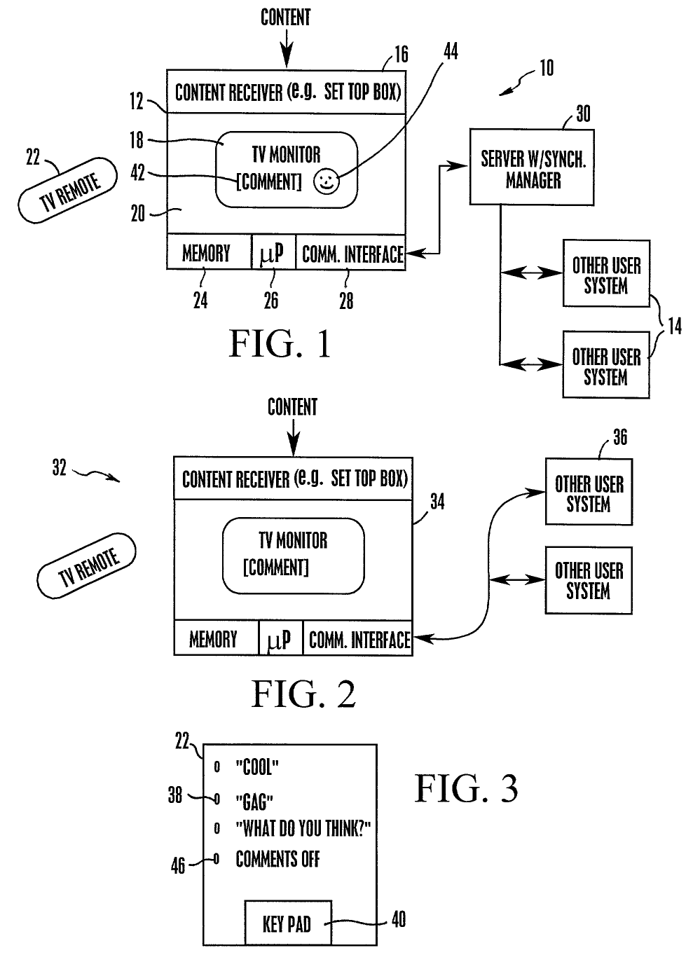

FIG. 2 shows a system 32 that includes a user TV 34 and one or more companion TVs 36 and that is in all substantial respects identical to the system 10 shown in FIG. 1, with the following exception. No server is provided intermediate the TVs. Instead, the system 32 is a peer-to-peer system in which the TV 34 communicates directly with the companion TVs 36 via, e.g., a wireless or wired connection. In such an embodiment, the communication interfaces of the TVs are wireless or wired communication transceivers, and the functions that would otherwise be undertaken by the server in FIG. 1 are executed by the TVs 34, 36.

FIG. 3 shows the details of one exemplary, non-limiting remote control user interface 22. In addition to or in lieu of conventional TV remote control buttons, the user interface 22 can include comments buttons 38 that can be manipulated to cause preselected comments to be received by the user TV 12 and transmitted to one or more of the companion TVs 14, such that the visual or audio comments are superimposed over TV programming on the monitor of one or more of the companion TVs 14. Also, the interface 22 can include a keypad 40 that can be manipulated by a user to type in a comment, or to identify a recipient of a comment. Other means can be used to identify a single recipient or a group of recipients. Or, the TVs 12, 14 can simply be in group communication in a private chat-like session.

It is to be understood that comments 42 from the companion TVs 14 can likewise be displayed on the monitor 18 of the user TV 12, as shown in FIG. 1. Moreover, a sender icon or avatar 44 or sender identification (ID) can be displayed along with the comment, to identify the sender of the comment. These icons/IDs can be stored in the memory 24 and/or, in the case of the server-based system 10 shown in FIG. 1, at the database of the server 30, and when a comment signal from a particular TV is sent, the corresponding icon/ID is correlated to it and displayed. The use of icons also help to distinguish multiple viewers' comments.

In any case, a comment can include an alpha-numeric string. It can also include a still or moving picture, or it can be an audio comment that is played by the TV. In the case of preselected comments, it can be a pithy string such as “cool”, “gag”, “what do you think?”, or other comment that is easily input simply by toggling one of the buttons 38. If desired, the viewer of the user TV 12 can disable comments from the companion TVs 14 from appearing on the monitor 18 by toggling a “comments on/off” button 46 on the interface 22 (FIG. 3).

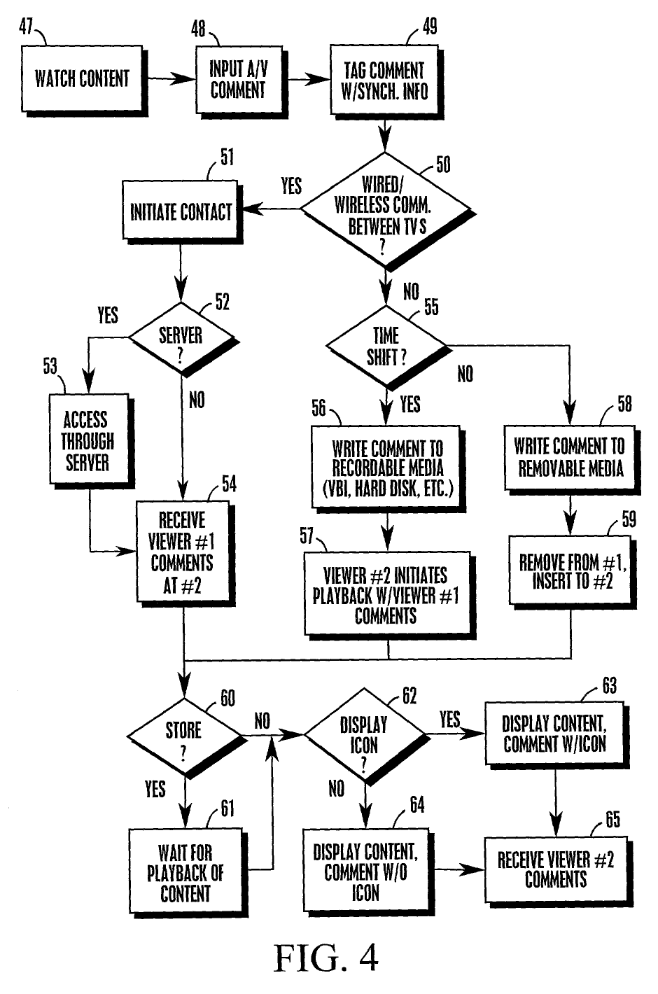

Now referring to FIG. 4, the overall logic can be seen. For convenience, a flow chart format is used in FIG. 4, it being understood that the present logic can be equivalently depicted in a state diagram. Commencing at block 47, a first viewer (denoted “#1” in FIG. 4) watches content, and at block 48 inputs audio/visual comments regarding the content as described above at the inputting TV. If desired, the comments can be associated with synchronization information at block 49 by, e.g., timestamping the comments with a time tag.

Proceeding to decision diamond 50, when two TVs (“#1” and “#2” in FIG. 4) are linked via wired or wireless link, the logic moves to block 51 to initiate communication between the TVs. Proceeding to decision diamond 52, when a server is present in the communication link as shown in, e.g., FIGS. 7, 12, and 13 below, the logic moves to block 53 to enable TV #2 to access the TV #1 comments through the server. Comments from the viewer of the TV #1 are then received at the TV #2.

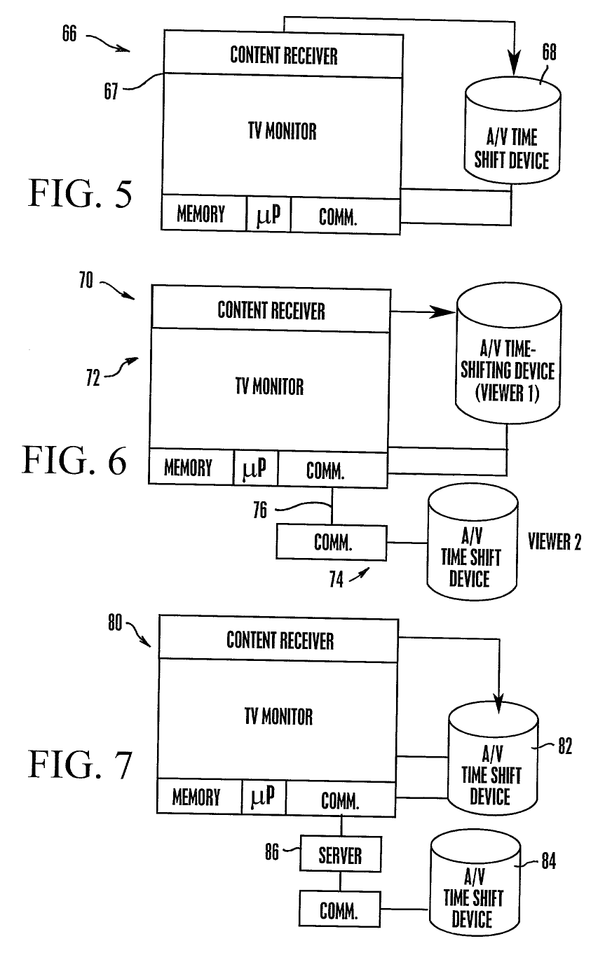

In contrast, when a time-shift is to be used by means of the below-described time-shifting devices shown in, e.g., FIGS. 5-7, 11, and 13, the logic moves from decision diamond 55 to block 56 to write the comment to a recordable medium, such as a hard disk drive, or to place the comment in the vertical blanking interval (VBI) of the TV. In this way, a person on the east coast can input a comment intended for a west coast viewer during a broadcast program, and the comment would be displayed at a later time on the recipient TV, i.e., when the program is broadcast on the west coast. Moreover, simultaneous start times of programming from personal video recorders such as the device known as TiVO, or from DVD players, VCRs, etc. are enabled. Block 57 indicates that a second viewer of the TV can initiate playback of the comments of a first viewer.

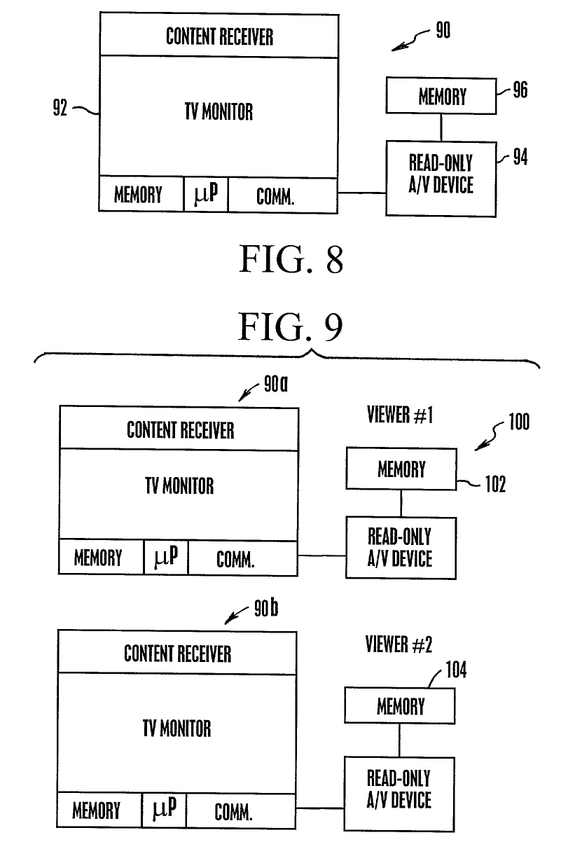

For the embodiments shown in, e.g., FIGS. 8 and 9 below, which employ removable media such as Sony's Memory Stick®, the logic can flow to block 58 to write the comment to the removable media. Proceeding to block 59, the removable media can be removed from the TV #1 and associated with the TV #2.

From blocks 54, 57, and 59 the logic may flow to decision diamond 60 to determine whether a viewer has indicated a desire to store the comments, perhaps with the associated content, for playback at a later time. If so, the later time is awaited at block 61. At decision diamond 62, if an icon representing a commenting viewer is to be displayed, the logic displays the content with associated comment and icon at block 63. Otherwise, the logic displays the content with associated comment without an icon at block 64. Viewer #2 comments can be received at block 65.

It can be appreciated from the above that embodiments of the present system can receive a comment from an inputting TV and display comments on the same or a recipient TV by, e.g., superimposing the comments on a display of the part of the program that was being viewed by the sender when the comment was input. The comment can include a header identifying the sender, so that the appropriate icon/ID can also be displayed if desired. The comment can be displayed immediately regardless of the program, or it can be time synchronized as set forth above. Yet again, the comment can be stored in the onboard memory 24 and displayed only on demand from the user of the recipient TV as indicated by, e.g., the user toggling the “comments on/off” button 46.

FIGS. 5-13 show alternate embodiments of the system 10 depicted in FIG. 1 which use TVs that are identical in configuration and operation with the TV 12 and remote 20 disclosed above, with the noted exceptions below.

FIG. 5 shows a system 66 which may use multiple TVs or may consist of only one TV 67. The system 66 contains an audio-video time shifting device 68 which allows sharing of comments over a temporal gap instead of just physical gaps.

This audio-video time-shifting device 68 may be a device such as a hard-disk recorder system PVR (personal video recorder like TiVo), or a home server or may even be as simple as a common VCR (video cassette recorder).

As in the case of the system 10, in the system 66 shown in FIG. 5 comments are input as the show is being watched by a first viewer and are stored as content synchronous events such that watching at a later time, a second viewer will see and hear comments made by the first viewer, as if the first viewer were present. In this case, both viewers use the same equipment.

FIG. 6 shows another embodiment, designated 70, that includes two or more TV systems 72, 74 that can be substantially identical to each other, for enabling two viewers who are located in respective physical locations and even different times to share comments with other. All the steps are the same as above except that the audio-visual comment file is transmitted by wireless or wired connection 76.

The system 70 shown in FIG. 6 also allows a second viewer to add further comments to first viewer's comments and then send the combined comments to a third viewer. This is analogous to joke e-mails that often are forwarded from friend to friend.

FIG. 7 shows yet another system 80 where two or more time-shifting audio-video devices 82, 84 are connected to a server or servers 86 via respective communication interfaces. The functionality of the system 80 is similar to that of the system 70 shown in FIG. 6, except that the server 86 may allow the sending of the same programming with comments to multiple friends simultaneously. The server 86 also facilitates increased security or copy-protection/control enhancements.

FIG. 8 shows system 90 including a TV 92 and at least one conventional read-only audio-video media device 94 which may be, without limitation, a DVD player, CD player, etc. Additionally, a portable memory 96 that stores viewer comments and synchronization information can be engaged with the read-only device 94. The memory 96 may be removable media such as Memory Stick, Compact Flash, etc. or it may be memory which is embedded in the audio-video device or TV. The functionality of the system 90 is the essentially the same as that of the system 66 shown in FIG. 5, except that the memory 96 is required to allow synchronization and comment information to be stored. The memory 96 is read back out to enable comments to be played back when a viewer watches the content.

FIG. 9 shows a system 100 that essentially is an extension of the system 90 shown in FIG. 8, wherein first and second system 90a, 90b are used such that a viewer of the system 90a may share the comments in a physically discrete location from that of a viewer of the system 90b. It is to be understood that each system 90a, 90b is essentially identical to the system 90 shown in FIG. 8. The comments and synchronization data are stored in a memory, such as respective removable media 102, 104. In this case, the media 104 from the system 90b can be transported with read-only media (i.e. DVD movie, CD, etc.) to the system 90a, where the DVD movie, etc. can be engaged with the read-only device of the system 90a. Also, the removable media 104 can be engaged with the system 90a memory storage, which may be a stand-alone reader device or integrated into the TV or read-only audio-video device. As the audio-video material from the DVD, etc. is played back, the comment data from the removable media 104 is superimposed on the audio-video content per the comment and synchronization data set by the viewer associated with the system 90b and stored on the removable media 104.

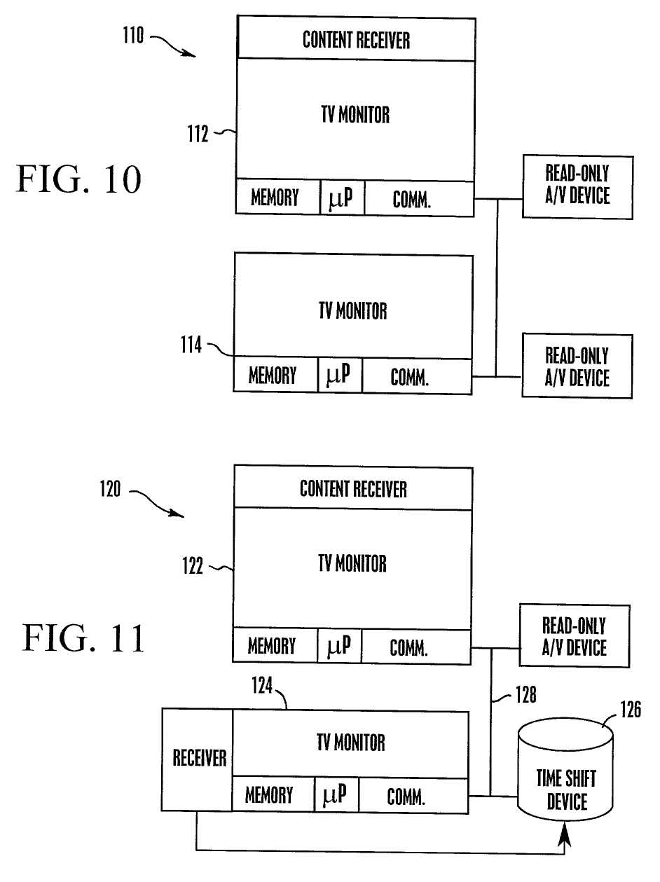

FIG. 10 shows a system 110 that is similar to the system 100 shown in FIG. 9, except that instead of using removable media to transfer comment and synchronization data, the data is transferred via a peer-to-peer wireless or wired connection 112 between two TV systems 114, 116. This additionally allows a second viewer to comment on a copy of the same title commented on by a first viewer and view comments without physically using the same media (i.e. the same DVD movie, CD, etc.) FIG. 11 shows a system 120 having a first TV system 122 that is substantially identical to the system 92 shown in FIG. 8 (perhaps without the removable media) and a second TV system 124 that is substantially identical to the system 66 shown in FIG. 5. The system 120 shown in FIG. 11 extends the above-noted commenting capability to sources such as game consoles (e.g., PlayStation, XBox, Nintendo, etc.) by having the second system 124 include a time-shifting audio-video device 126. The device 126 can download, via a wired or wireless link 128, a video stream from the first TV system 122 along with the comments and synchronization information in real-time or in a streaming format to the receiving time-shifting audio-video device 126 for later viewing by a viewer of the second system 124.

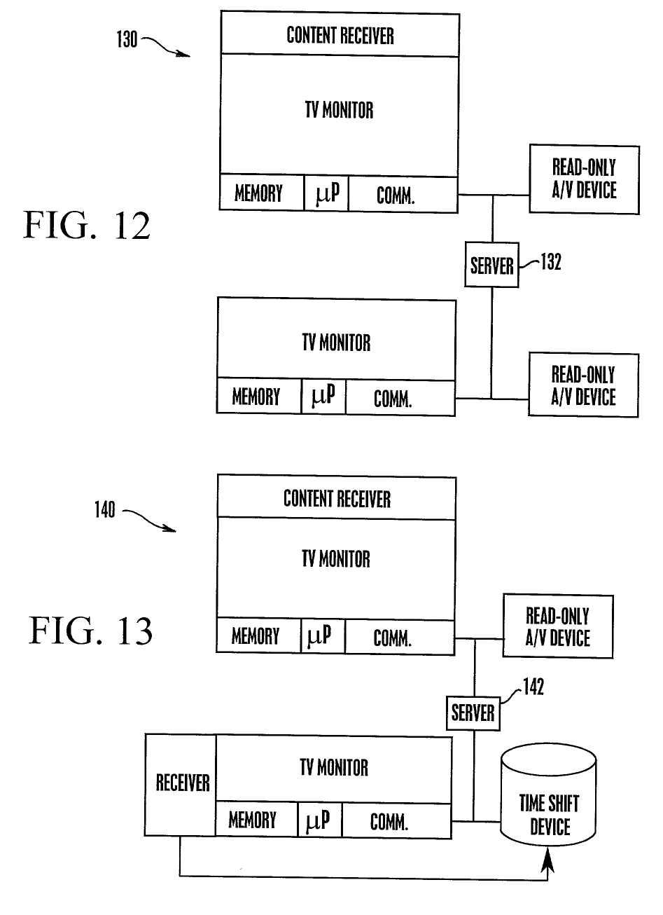

FIGS. 12 and 13 respectively show systems 130, 140 that are the same as the respective systems 110, 120 shown in FIGS. 10 and 11 with the exception that respective intermediary servers 132, 142 are used to connect the first and second TV systems, rather than a peer-to-peer connection. This allows a second viewer to download comment data from a first viewer at his/her own convenience. Also, it enables sharing with multiple viewers simultaneously.

While the particular SYSTEM AND METHOD FOR SHARING USER COMMENTS ON TV SCREENS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A system, comprising:
a first user TV;
a second user TV; and
an input device associated with at least the first user TV,
the input device being manipulable by a user to input at least one audio and/or visual comment,
the comment being displayable on the second user TV.

2. The system of claim 1, wherein the input device is a remote control device.

3. The system of claim 1, further comprising:
a comment server communicating with the TVs,
the comment server transferring comments input at the first TV to the second TV.

4. The system of claim 1, wherein the TVs communicate with each other directly to transmit comments therebetween.

5. The system of claim 4, wherein the TVs communicate via wireless links.

6. The system of claim 1, wherein the comment is presented along with a symbol associated with the user.

7. The system of claim 1, wherein the comment is presented along with a user ID.

8. A method for sharing TV program-related comments between first and second users of respective first and second TVs, comprising:
receiving a comment from the first user via an input device in wireless communication with the first TV; and
sending the comment to the second TV for display of the comment thereon.

9. The method of claim 8, wherein the input device is a remote control device.

10. The method of claim 8, further comprising:
transferring comments input at the first TV to the second TV.

11. The method of claim 8, further comprising establishing direct communication between the TVs to transmit comments therebetween.

12. The method of claim 11, comprising establishing the direct communication using a wireless link.

13. The method of claim 8, comprising presenting the comment along with a symbol associated with the user.

14. The method of claim 8, comprising presenting the comment along with a user ID.

15. A TV, comprising:
a TV monitor displaying televised content thereon,
the monitor also displaying at least one comment received from a companion TV.

16. The TV of claim 15, wherein the comment includes at least one alpha-numeric string.

17. The TV of claim 15, wherein the monitor also displays a symbol associated with the user.

18. The TV of claim 15, wherein the monitor also displays an ID associated with the user.

19. The TV of claim 15, further comprising:
an input device for inputting a comment; and
a transceiver sending the comment to the companion TV.

20. The TV of claim 19, wherein:
the input device is a remote control device; and
the transceiver is a wireless transceiver.

21. The system of claim 1, wherein the comment is displayed on the second TV on demand.

22. The method of claim 8, wherein the comment is displayed on the second TV on demand.

23. A system for sharing TV program-related comments between first and second users of respective first and second TVs, comprising:
means for receiving a comment from the first user via an input device in wireless communication with the first TV; and
means for sending the comment to the second TV for display of the comment thereon.

24. The system of claim 23, wherein the input device is a remote control device.

25. The system of claim 23, further comprising:
means for transferring comments input at the first TV to the second TV.

26. The system of claim 23, further comprising means for establishing direct communication between the TVs to transmit comments therebetween.

27. The system of claim 26, comprising means for establishing the direct communication using a wireless link.

28. The system of claim 23, comprising means for presenting the comment along with a symbol associated with the user.

29. The system of claim 23, comprising means for presenting the comment along with a user ID.

30. The system of claim 26, comprising means for establishing the direct communication using a wired link.

31. The TV of claim 19, wherein:
the input device is a remote control device; and
the transceiver is a wired transceiver.

32. The system of claim 4, wherein the TVs communicate via a wired link.

33. The method of claim 8, comprising sending the comment via a wired link.

34. The method of claim 11, comprising establishing communication using a wired link.

35. A system comprising:
a TV;
an audio-video time shifting device; and
an input device associated with the user TV,
the input device being manipulable by a user to input at least one audio and/or visual comment,
the comment being displayable to user during time-shifted playback of the audio-visual content on TV.

36. The system of claim 35, wherein the audio-video time shifting device is a hard disk recorder.

37. The system of 35, wherein the audio-video time shifting device is a video cassette recorder (VCR).

38. The system of claim 35, wherein the audio-video time-shifting device is a read-only media player.

39. A system comprising:
a first user TV;
a second user TV; and
an first user audio-video time shifting device; and
an second user audio-video time shifting device; and
an input device associated with at least the first user TV,
the input device being manipulable by a user to input at least one audio and/or visual comment,
the comment being displayable on the second user TV.

40. A system comprising:
a TV;
a playback read-only audio-video device;
a memory storage; and
an input device associated with the user TV,
the input device being manipulable by a user to input at least one audio and/or visual comment,
the comment being displayable to user during time-shifted playback of the audio-visual content on TV.

41. The system of claim 40, wherein the playback device is a DVD player or CD player.

42. The system of claim 40, wherein the memory storage is a removable memory storage media.

43. A system comprising:
a first user TV;
a first playback read-only audio-video device associated with the first TV;
a memory storage;
a second user TV;
a second playback read-only audio-video device associated with the second TV; and
an input device associated with at least the first TV,
the input device being manipulable by a user to input at least one audio and/or visual comment,
the comment being displayable on the second user TV and storable on the memory storage.

44. The system of claim 43, wherein at least the first playback device is a DVD player or CD player.

45. The system of claim 43, wherein the memory storage is a removable memory storage media.

46. A system comprising:
a first user TV;
a first playback read-only audio-video device associated with the first TV;
a second user TV;
a second playback read-only audio-video device associated with the second TV;
a communication link between the TVs; and
an input device associated with at least the first user TV,
the input device being manipulable by a user to input at least one audio and/or visual comment,
the comment being communicable over the link for display on the second user TV.

47. The system of claim 46, wherein at least the first playback device is a DVD player or CD player.

48. The system of claim 46, wherein the memory storage is a removable memory storage media.

49. The system of claim 46, wherein the communication link is a wireless link.

50. The system of claim 46, wherein the communication link is a wired link.

51. A system comprising:
a first user TV;
a playback read-only audio-video device associated with the first TV;
a second user TV;
an audio-video time shifting device communicating with at least one of the TVs;
a communication link between the TVs; and
an input device associated with at least the first user TV,
the input device being manipulable by a user to input at least one audio and/or visual comment,
the comment being displayable on the second user TV.

52. The system of claim 51 wherein the playback read-only audio-video device is a game console.

53. The system of claim 51, wherein the playback read-only audio-video device is a DVD player or CD player.

54. The system of claim 51, wherein the communication link is a wireless link.

55. The system of claim 51, wherein the communication link is a wired link.
